(19) United States
(12) Patent Application Publication
(10) Pub. No.: US 2010/0050949 A1
(43) Pub. Date: Mar. 4, 2010

(54) Portable container and leash adapted for pet

(76) Inventor: Chih Heng Hsieh, Taichung (TW)

Correspondence Address: Hsieh Chih Heng, P.O.Box 55-846, Taipei, 104, TW

(21) Appl. No.: 12/384,955

(22) Filed: Apr. 13, 2009

(30) Foreign Application Priority Data
Aug. 28, 2008 (TW) 97215489

(51) Int. Cl. A01K 1/10; A01K 5/01

(52) U.S. Cl. 119/61.56

(57) ABSTRACT

A portable pet device comprising a foldable container which is collapsibly folded from a flat one-piece sheet to form a chamber for storing food or water in the chamber for feeding a pet; and a leash detachably fastenable with the container, whereby the container may be fastened to a distal end of the leash for a convenient holding of the container and also for reinforcing the distal end of the leash for preventing tangling of the leash on the pet's neck or body.

### BACKGROUND OF THE INVENTION

When walking or airing with a pet like dog, a food or water container should be prepared and carried ready for feeding the pet. Since the food container is always separately carried without being attached to a leash, it may cause inconvenience to the pet owner.

U.S. Pat. No. 6,016,772 disclosed a leash having a collapsible bowl for providing pet's food. However, such a prior art still has the following drawbacks:
1. Even an accordion-fold bowl (35) may be served as a food bowl for feeding the pet, the storing volume in the accordion-fold bowl is very small to quite limit the food quantity for the pet.
2. The food debris or residue may be easily accumulated in the apertures or cavities in the accordion-fold bowl, causing difficult cleaning for the bowl and also easily causing contamination or growth of bacteria or fungi to be hazardous to the pet's health and living environment.
3. The bowl is always formed in-situ on the leash and can not be separated or removed from the leash for an independent service of the bowl.

The present inventor has found the drawbacks of the prior art and invented the present portable container detachably fastened to a pet leash.

### SUMMARY OF THE INVENTION

The object of the present invention is to provide a portable container (or bowl) which is collapsibly folded from a flat one-piece sheet to form a chamber for storing food or water in the chamber for feeding a pet; and a leash detachably fastenable with the container, whereby the container may be fastened to a distal end of the leash for a convenient holding of the container and also for reinforcing the distal end of the leash for preventing tangling of the leash on the pet's neck or body.

### BRIEF DESCRIPTION OF THE DRAWINGS

FIG. 1 shows a flat one-piece sheet of the portable foldable bowl of the present invention.

FIG. 2 shows a folded or assembled bowl of the present invention.

FIG. 3 is an illustration showing the bowl as wound up and fastened to the leash in accordance with the present invention.

FIG. 4 is a cross-sectional drawing of the present invention as viewed from Line 4-4 of FIG. 3.

FIG. 5 is a perspective illustration of the present invention when the foldable bowl is fastened or coupled to the leash.

FIG. 6 shows the application of the present invention when attached to a dog pet.

### DETAILED DESCRIPTION

As shown in the drawing figures, the present invention comprises: a foldable bowl (or container) 1, and a leash 2 for detachably fastening the bowl 1 thereon.

The foldable bowl 1 is unfolded to be a flat one-piece bowl sheet 11 as shown in FIG. 1. Such a sheet 11 of the bowl may be made of Thermoplastically Processable PU Elastomer (TPU), or other suitable materials, not limited in the present invention.

The sheet 11 of the bowl 1 is formed as a square or rectangle sheet, including four right-angle corner portions 14 formed on the square or rectangle corners of the sheet 11, each right-angle (A₁=90°) corner portion 14 having a pair of semi-corner portions 141, 142 collapsibly separated by a diagonal line 12 diagonally formed on each right-angle corner portion 14 with each semi-corner portion 141 or 142 defining a half-right angle or 45 degrees (A₂) between the diagonal line 12 and each square side of the square bowl sheet 11. The above-mentioned diagonal line 12 is a hypothetical line, not really existing on the sheet 11 and is just provided for a clear explanation of the present invention.

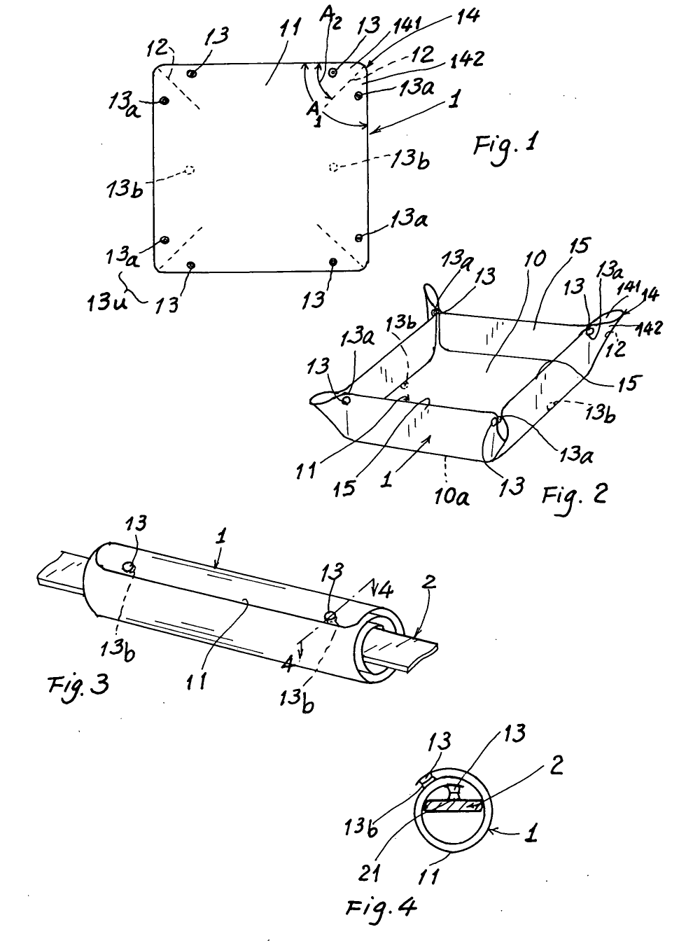

The bowl 1 includes four fastener units 13u, each fastener unit 13u disposed in each right-angle corner portion 14 of the sheet 11, and each fastener unit 13u composed of a male connector 13 formed in a first semi-corner portion 141 and a female connector 13a formed in a second semi-corner portion 142 and foldably engaged with (or unfoldably disengaged from) the male connector 13 to fold the two semi-corner portions 141, 142 along the diagonal line 12 and to correspondingly fold and upwardly erect two neighboring side walls 15 (from FIG. 1 to FIG. 2) contiguous to the two semi-corner portions, 141, 142 of each said right-angle corner portion 14. By engaging each male connector 13 and female connector 13a of each fastener unit 13u on each right-angle corner portion 14, four side walls 15 will be upwardly folded and erected to form a three-dimensional assembled bowl 1 (FIG. 2), having a chamber or interior 10 defined within (and fenced by) the four side walls 15 and a bottom portion 10a of the sheet 11, adapted for storing food or water for feeding a pet such as a dog, a cat or any other pet animals.

Upon engagement of each fastener unit 13u in each corner portion 14, the four corner portions 14 are upwardly erected and folded to simultaneously fold and erect the four side walls 15 to thereby assemble the bowl 1 as shown in FIG. 2. Upon disengagement each fastener unit 13u in each corner portion 14, the bowl 1 (as assembled in FIG. 2) will be unfolded to be a flat one-piece sheet 11 as shown in FIG. 1.

The bowl 1, once being assembled, may be stored with foods or water in the chamber 10 within the bowl for pet's eating or drinking. However, the bowl 1 may also be provided for storing other articles or objects, not limited in the present invention.

The fastener unit 13u, composed of the male connector 13 and the female connector 13a, may include: a button 13 and a button socket 13a; a male buckle 13 and a female socket 13a; a male coupling member 13 and a female coupling member 13a; and a male connector 13 and a female connector 13a engageable with each other; not limited in this invention.

Each sheet 11 of the foldable bowl 1 is formed with two back-side female connectors 13b, respectively engaged with two male connectors 13 formed on the upper (or top) side of the sheet 11, whereby upon winding of the bowl sheet 11 (as shown in FIG. 3), the male connectors 13 will be respectively engaged with the back-side female connectors 13b to stably wind the sheet 11 to be a “roll” for easy storage or carrying. Or, the wound sheet 11 of bowl 1 may be jacketed on the leash 2 as shown in FIGS. 3 and 4.

In FIGS. 4 and 3, the leash 2 is formed thereon with a female leash connector 21 to be engaged with the male connector 13 of the bowl sheet 11 so that the wound bowl sheet 11 may be stably fastened on the leash 2 for a safe and convenient carrying of the bowl 1 with the leash 2. Naturally, the wound bowl 1 may also be stored in a backpack or other containers, not limited in this invention.

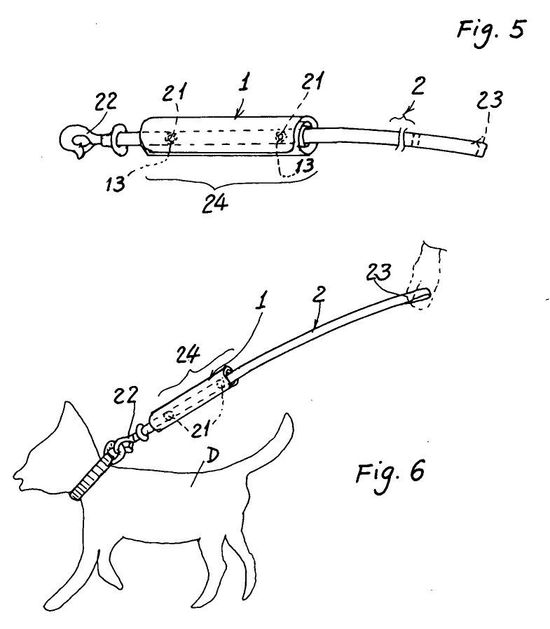

The leash 2, as shown in FIGS. 5 and 6, includes: at least one female leash connector (or connector) 21 formed on the leash 2 adjacent to a distal end 24 of the leash; and a grip 23 formed on a proximal end of the leash, adapted to be held by a pet's owner as shown in FIG. 6. Preferably, there may be two female leash connectors 21 formed on the leash 2 to be respectively engaged with two male connectors 13 formed on the bowl sheet 11 as shown in FIGS. 4, 5.

Once the bowl sheet 11 is wound and jacketed on the distal end 24 of the leash 2 near the pet (a dog D as shown in FIG. 6), the wound bowl sheet 1 will become a “reinforcing sleeve” jacketed on the front end portion of the leash 2 to significantly protect the pet D to prevent from tangling of the pet's neck or body portion since the flexible leash portion near the pet's body has been well disposed within the wound bowl 1 (having a proper rigidity) to be a “reinforced portion” on the front (distal) end portion of the leash 2.

So, the foldable bowl 1 of the present invention plays double roles, both for serving as a feeding bowl for the pet and also for reinforcing the front end portion of the leash 2 for safely protecting a pet without being tangled or injured by a flexible leash 2.

The foldable bowl 1 may be quickly assembled or folded to be a three-dimensional assembled bowl from a flat one-piece bowl sheet 11 for feeding a pet. The three-dimensional assembled bowl 1 may also be quickly unfolded to be a flat sheet 11 and then wound to be jacketed or fastened on the leash 2 for a convenient handling of the bowl and also for safe airing or walking a pet by jacketing the wound bowl 2 on the front portion of the leash 2 for preventing tangling or injury of the pet.

The foldable bowl 1 is easily folded for conveniently feeding a pet; or quickly unfolded and then wound for a convenient handling of the bowl and for a safe leashing of the pet to thereby be superior to the prior art.

The present invention may be further modified without departing from the spirit and scope of the present invention.

I claim:

1. A portable pet device comprising:
a foldable bowl operatively folded from a flat one-piece square or rectangle bowl sheet, including four fastener units respectively formed on four right-angle corner portions of the square or rectangle bowl sheet; each said right-angle corner portion having a pair of semi-corner portions collapsibly separated by a diagonal line diagonally formed on each said right-angle corner portion; each said semi-corner portion having a side wall of said bowl sheet adjacent to said semi-corner portion; each fastener unit, composed of a male connector and a female connector detachably engageable with each other, said male connector and said female connector respectively formed on said pair of semi-corner portions of each said right-angle corner portion; whereby upon engagement of each said male connector with each said female connector of each said fastener unit, each said pair of semi-corner portions will be upwardly folded, coupled and erected to correspondingly fold four side walls of said bowl sheet to be a three-dimensional assembled bowl having a chamber confined within the four side walls and a bottom portion of the bowl sheet for storing foods or articles in said chamber; and upon unfolding of said three-dimensional assembled bowl to be a flat bowl sheet, said flat bowl sheet is operatively wound to be jacketed or fastened on said leash for a safe convenient carrying.

2. A portable pet device according to claim 1, wherein said bowl sheet is made of thermoplastically processable poly-urethane elastomer.

3. A pet device according to claim 1, wherein said bowl sheet includes at least one back-side female connector formed on a back of said bowl sheet and adapted to be engaged with at least a male connector formed on an upper (or top) side of said bowl sheet, whereby upon winding of said bowl sheet, said back-side female connector will be engaged with said male connector to fasten said bowl sheet at a stable wound state.

4. A pet device according to claim 1, wherein said leash includes: at least a female leash connector formed on a distal or front end portion of said leash to be engaged with one said male connector of said bowl sheet, whereby upon engagement of said male connector of a wound bowl sheet with said female leash connector, said wound bowl will be stably fastened on said leash.

5. A foldable bowl comprising:
a flat one-piece square or rectangle bowl sheet having four right-angle corner portions formed on four corners of said bowl sheet;
each said right-angle corner portion composed of a pair of semi-corner portions collapsibly separated by a diagonal line diagonally formed on each said right-angle corner portion; each said right-angle corner portion having a fastener unit formed thereon, each said fastener unit including a male connector and a female connector operatively engageable each other and respectively formed in said two semi-corner portions, and each said semi-corner portion having a side wall of said bowl sheet adjacent to said semi-corner portion; whereby upon engagement of each said male connector with each said female connector, each said pair of semi-corner portions will be upwardly folded and erected to correspondingly fold every two neighboring side walls of said bowl sheet adjacent to said pair of semi-corner portions to thereby upwardly fold and erect four side walls of the bowl sheet to form a three-dimensional assembled bowl having a chamber confined within said four side walls and a bottom portion of said bowl sheet for storing foods or articles in said chamber of said bowl.

6. A foldable bowl according to claim 5, wherein said bowl sheet is made of thermoplastically processable poly-urethane elastomer.

7. A foldable bowl according to claim 5, wherein said bowl sheet includes at least one back-side female connector formed on a back side of said bowl sheet and adapted to be engaged with at least a male connector formed on an upper (or top) side of said bowl sheet, whereby upon winding of said bowl sheet, said back-side female connector will be engaged with said male connector to fasten said bowl sheet at a stable wound state.
